(19) United States
(12) Patent Application Publication
(10) Pub. No.: US 2005/0043922 A1
(43) Pub. Date: Feb. 24, 2005

(54) Analysing events

(76) Inventors: Galia Weidl, Steinenbronn (DE); Gerhard Vollmar, Meckenheim (DE)

Correspondence Address: VENABLE, BAETJER, HOWARD AND CIVILETTI, LLP, P.O. BOX 34385, WASHINGTON, DC, 20043-9998, US

(21) Appl. No.: 10/845,518

(22) Filed: May 14, 2004

(30) Foreign Application Priority Data
Nov. 16, 2001 (GB) 0127552.8
Nov. 15, 2002 (WO) PCT/EP02/12824

(51) Int. Cl. G06F 15/00; G06F 11/30

(52) U.S. Cl. 702/183

(57) ABSTRACT

An arrangement for provision of information about causes of events in association with an equipment. The arrangement includes a data storage medium for storing beforehand prepared data that associates with the equipment. The data provides predetermined information about events that can associate with the equipment, hypotheses for the root causes of the events and symptoms for the hypotheses. A processor analyses a plurality of root cause hypotheses by processing information obtained from the data storage medium.

### FIELD OF THE INVENTION

The present invention relates to analysis of events, and in particular, but not exclusively, to analysis for determining at least one possible root cause for an event that has occurred or that may occur in association with the subject of the analysis. The analysis can be provided by a computerised analyser function.

### BACKGROUND OF THE INVENTION

Various types of equipment is used in by the industry for various purposes. The equipment may comprise a component of a larger industrial facility such as a factory or a process. The term equipment shall also be understood to refer to any subsystem e.g. in a factory. A subsystem may consist e.g. a manufacturing cell or other unit of an industrial facility, a machine, a process stage or an element of a process stage and so on.

Information about events in association with an equipment and/or operation thereof may need to be provided for various reasons. An operator of an equipment e.g. in a factory may wish to analyse what was the root cause of an event. The operator may also wish to be able predict what will happen if an action is taken. The results of the analysis could then be used e.g. as a support in the control of a process, for producing information that is needed later on e.g. when processing an end product of the process, for diagnostic of events such as a fault or other abnormality in a machine, for being able to avoid taking action that may be harmful or even dangerous, and so on. The operator may also wish to collect as evidences information on a deviation from optimal operating conditions of the equipment, to analyse in advance what might be the root cause of the deviation and to remove the source of the problem before any actual failure occurs. It is also possible to diagnose products or their parts and/or optimise assets by means of analysis of the production process thereof.

The term ‘event’ shall be understood to refer to anything that may occur in association with an equipment, e.g. when the equipment is operated. For example, the event may comprise an abnormality or failure/fault or any other deviation from normal operation conditions of an equipment such as a motor or a unit comprising a motor, a gear and a machine to be rotated by the motor.

Computerised analysers are known. The computerised analysers comprise hardware and software for processing input data in accordance with a predefined set of analysing rules. Different information collecting and other monitoring means (e.g. different sensors, meters and so on) may be provided for collection of the data. The data may be collected and input into the system automatically, semi-automatically, or manually.

Information available for analysing deviations from normal operation conditions such as failures or other abnormalities or events may be incomplete. This may be especially the case in facilities comprising a substantially large number of different equipment. A facility may comprise an equipment of which no beforehand determined or learned information is available. The domain knowledge or data associated with a facility or some part of the facility to be analysed and/or the event domain may thus be incomplete and/or include uncertainties.

The inventors have found that there is a need for a solution that accelerates the analysis for finding the initial cause of an event such as the source of a problem or other abnormality. The user might find analysis that possesses the power of quick deduction under uncertain or incomplete data useful as this would assist in provision of quick guidance for a failure analyst.

### SUMMARY OF THE INVENTION

Embodiments of the present invention aim to address one or several of the above problems.

According to one aspect of the present invention, there is provided an arrangement for provision of information about causes of events in association with an equipment, comprising:
a data storage medium for storing beforehand prepared data that associates with the equipment, said data containing predetermined information about events that can associate with the equipment, hypotheses for the root causes of the events and symptoms for the hypotheses; and
a processor arranged to analyse a plurality of root cause hypotheses by processing information obtained from the data storage medium.

In a more specific form at least two root cause hypotheses are processed simultaneously. Said at least two root cause hypotheses may share at least one common symptom.

Only a predetermined number of variables may be stored in the data storage medium. The number may be fixed.

The data may be stored as objects, said objects being organised onto a model wherein at least one of the objects includes information about a possible event, at least one of the objects includes information of hypothesis associated with possible root causes of the event and at least one of the objects includes information associated with symptoms of said possible causes. The data model may comprise a causally oriented data model. The causally oriented data model may be generated by processing a structured data model. The causally oriented data model may comprise conditional probability information, said information being provided by calculating probabilities based on quantitative data associated with the frequency and/or weightings of the events.

Data for the analysis may be stored as an aspect of an object in a model describing a facility.

The data storage medium may comprise a computer readable data carrier. Alternatively the data storage medium may comprise a data entity that is provided for the analysis via a data network. The data storage medium may be prepared by an analysis information provision entity, said entity being arranged to gather information from various sources. The data storage medium may contain at least one causally oriented data model and program code means for processing said at least one causally oriented data model. The data storage medium may contain a structured data model, said processor being provided with translation means for generating a causally oriented data model based on the structured data model.

The processor and the storage medium may be provided in association with the equipment to be analysed. The processor and the storage medium may be provided in association with a portable device.

Input means may be provided for input of observed symptoms in a substantially real-time manner for provision of a substantially real-time root cause analysis.

The results of the root cause analysis can be updated by propagating observed symptoms through the causally oriented data model.

According to another aspect of the present invention there is provided a data storage medium for storing of data that has been prepared beforehand for use at an analyser, the data storage medium containing predefined information regarding possible events in association with an equipment in a form of data model that comprises objects containing information about the possible events, about root cause hypotheses for said possible events and symptoms for said hypotheses, and causality links for provision of probabilistic associations between the objects.

According to another aspect of the present invention there is provided a method of providing information about events in association with an equipment, comprising:
preparing a data model that associates with the equipment, said data model containing information about possible events, hypotheses for the root causes of the possible events and symptoms for the hypotheses;
storing the data model on a data storage medium;
input of symptoms into an analyser;
transferring data from the data storage medium to the analyser; and
analysing hypotheses for root causes by processing the symptoms input into the analyser and the data obtained from the data storage medium.

According to another aspect of the present invention there is provided a device comprising: means for provision of the intended operation of the device; data storage medium for storing of data that has been prepared beforehand for use in analysis of the device, the data storage medium containing predefined information regarding possible events in association with the device in a form of data model that comprises objects containing information about the possible events, about root cause hypotheses for said possible events and symptoms for said hypotheses; and a processor for analysing the operation of the device based on data stored in the data storage medium.

According to another aspect of the present invention there is provided a movable device for provision of analysis regarding an equipment, the movable device comprising:
a data storage medium for storing of data that has been prepared beforehand for use in analysis of the equipment, the data storage medium containing predefined information regarding possible events in association with the equipment in a form of data model that comprises objects containing information about the possible events, about root cause hypotheses for said possible events and symptoms for said hypotheses; and
a processor for analysing the operation of the equipment based on data stored in the data storage medium.

The embodiments may assist in provision of a substantially fast guidance tool for the operators. The analysis is based on data that is generated and/or modelled beforehand. Since it is not necessary to provide any substantial amounts of additional information regarding the subject of the analysis or to “train” the basic data, the data may therefore be ready for use immediately after the installation of e.g. a data carrier into an analyser.

An individual root cause analysis may be enabled for a particular equipment unit based on individual evidences gathered for said unit. The risk for incorrect basic data for an analysis may be reduced by the embodiments wherein the users may not be able to intervene with the data input and/or the analysis itself.

Some embodiments enable analysis that is not necessarily limited to only one possible root cause. A list of root causes may be ranked after probabilities whereby a substantially quick and flexible decision support may be provided. In some situations the users such as the operators might find is convenient if the most probable root cause or causes could be identified without a requirement for them to input and/or update any data for the analysis.

Predictive diagnostic may also be provided, especially in systems wherein real time root cause analysis is enabled. An operator may be provided with a tool for finding root causes for deviations and/or tendencies for deviations from normal operating conditions.

### BRIEF DESCRIPTION OF DRAWINGS

For better understanding of the present invention, reference will now be made by way of example to the accompanying drawings in which:

FIG. 1 is a schematic presentation showing a system provided with an analyser function;

FIG. 2 is a block chart for an embodiment of the present invention;

FIG. 3 is a flowchart in accordance with an embodiment;

FIG. 4 is a block chart showing use of a Bayesian scheme for root cause analysis;

FIG. 5 shows a hierarchically structured data model;

FIGS. 6 and 7 show causally oriented data models generated in accordance with the principles of the present invention;

FIG. 8 shows a graphical user interface that may be presented for a user;

FIG. 9 shows a data model wherein the information for the analysis is stored as aspect of an object;

FIG. 10 shows a portable user device; and

FIG. 11 shows an equipment unit provided with an analyser.

### DESCRIPTION OF PREFERRED EMBODIMENTS OF THE INVENTION

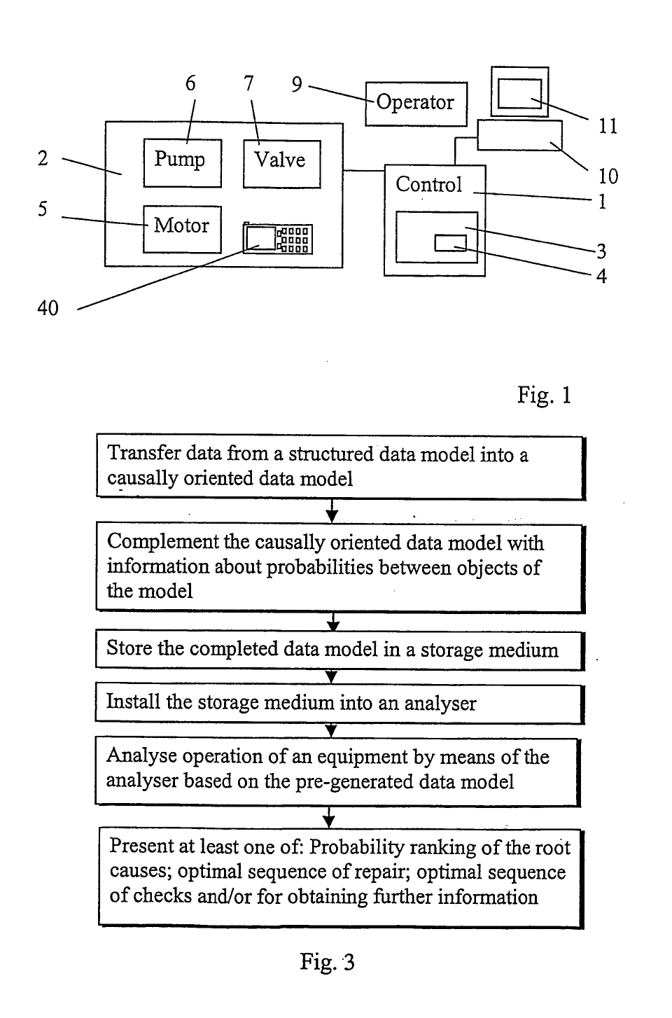

Reference is first made to FIG. 1 which shows a schematic view of a control system 1 adapted to monitor and control operation of equipment 5 to 7 provided in an industrial facility. The skilled person is familiar with the various functions of a control system, and these are therefore not described herein in any greater detail. It is sufficient to note that the control system 1 may be used for obtaining efficient and safe operation of a facility and/or for provision of information regarding the facility and/or equipment of the facility. To provide these objectives a control system may be adapted to monitor, analyse and manipulate the facility.

The type of the equipment or the facility to be controlled and/or analysed by means of the present invention as such does not form an essential element of the invention. Therefore these will not be described in any greater detail. It is sufficient to note that the equipment to be subjected to an analysis may comprise, without limiting to these, an entity such as a motor 5, a pump 6, a valve 7, and so on or a plurality of entities, such an entire manufacturing cell or a process stage 2. The facility may comprise any facility such as e.g. an industrial plant (e.g. a paper mill, a chemical plant), factory or a part of a plant or factory, a municipal facility, an office, a building or other construction, and so on.

The computerised control system includes an analyser entity 3. The analyser 3 may comprise data processor means adapted for processing data based on object oriented data processing techniques. Well known examples of object oriented technologies, without being limited to these, include known programming languages such as C++ or Java.

A user terminal 10 is for provision of e.g. an operator 9 with a user interface. The user terminal 10 is connected to the control system 1 by means of an appropriate communication link. The user terminal 10 is provided with display means 11 adapted for providing the user with a graphical user interface (GUI). Although not shown, the user terminal 10 may also be provided with interface means such as a keyboard, a touch screen, a mouse and other auxiliary devices.

In a form of the invention the analyser provides analysis in association with small scale or otherwise substantially simple applications, such as in maintenance applications of individual equipment 5 to 7 or an equipment unit 2 in a factory. When the basic data for the analysis is generated based on an assumption that the equipment has only a limited number of possible failures.

The basic data for the analysis may have been generated based on information that is common for the particular equipment. For example, a set of data may be generated for an equipment that is substantially commonly used in the industry in various locations and/or facilities. Therefore the analysis can be based on substantially descriptive and/or accurate data even in cases wherein no information is input regarding a particular equipment in a particular factory to be analysed. In other words, a ready to use data is provided for operators of a substantially commonly used equipment.

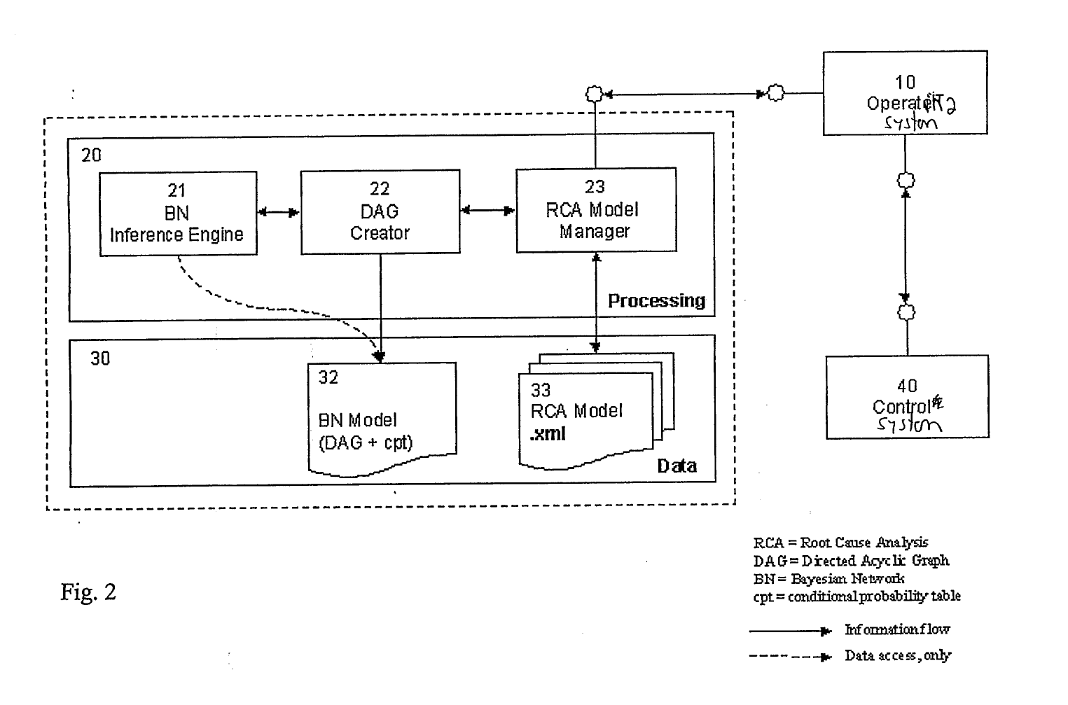

Examples of possibilities for preparation of the data stored in the storage mediums will be described in more detail later with reference to FIGS. 2 to 7. It is sufficient to note at this stage that the data preferably contains a predefined number of variables and has been prepared beforehand off-line. The number of variable may be fixed. If only a limited number of variables and limited number of hypothesis or scenarios is considered beforehand, an analyser needs to be able for reasoning under uncertainties. This is so since the gathered evidences may be incomplete or uncertain due to reasons such as measurement deviations/errors, changing operation conditions and so on.

The analyser entity 3 may analyse the operation of the various components of the equipment unit 2 based on data stored in a data storage medium 4. The skilled person is familiar with various possibilities for the provision of the data storage medium and therefore the possibilities will not be described in any great detail. It is sufficient to note that the dada storage medium may be any means capable of carrying and storing data for later use. For example, the storage medium may comprise a memory chip, a computer diskette (e.g. a floppy disc), a memory tape, a memory card, a compact disc (CD), digital video disc (DVD), and so on.

The storage medium 4 may have been prepared to contain the required basic data in a location that is remote from the equipment to be analysed. For example, a ready to use data storage medium may be provided by a maintenance service provider or the manufacturer of the equipment. The storage medium may then be provided for the owner of the equipment and used locally. That is, the storage medium is used in a location of the control system 1 and/or the equipment to be analysed. The storage medium 4 may be inserted into a data reader arrangement of the control system for download of the data to the analyser entity 3.

The analyser is preferably adapted to provide a root cause analysis by means of an automated simultaneous verification of several root cause hypotheses based on the data stored in the storage medium. Simultaneous processing may be especially advantageous if the root cause hypotheses share common symptoms. In addition of information about predefined number of variable or fixed number of variables the system may also employ learning that is based on event information.

The skilled person is familiar with the basic principles of the root cause analysis. As proposed by its name the root cause analysis can be used for determining root causes of problems. Removal of a determined root cause should also remove the origin of the problem behind an observed effect or failure. The root cause analysis may be used e.g. in a maintenance troubleshooting for anticipation and regulation of systemic causes of maintenance and/or process control problems, in finding the optimal sequence of maintenance and/or control actions, and for asset and/or process optimisation.

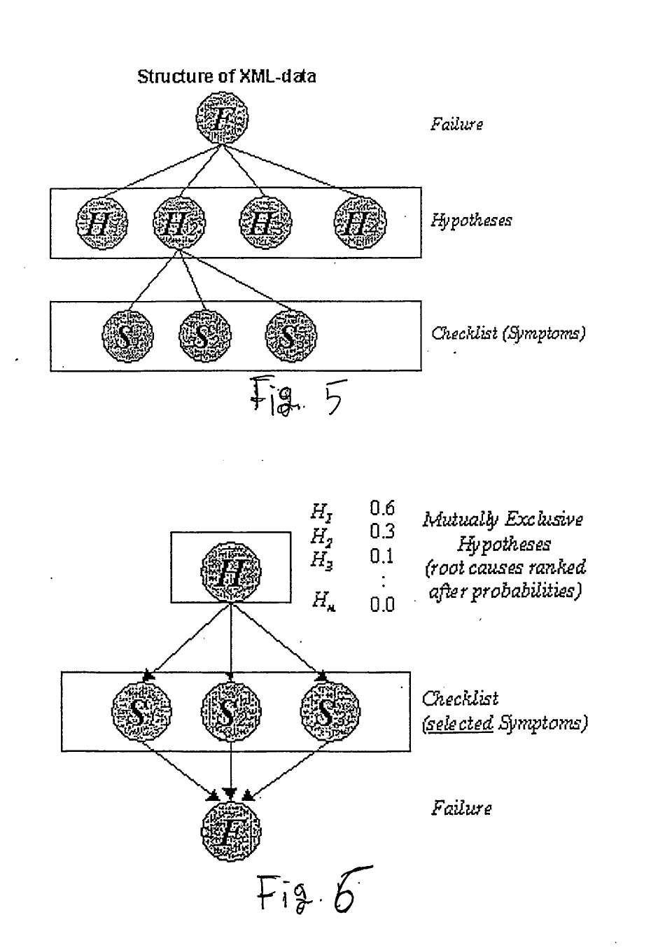

In a preferred embodiment the data to be analysed in organised in causally oriented data models. An analyser wherein the analysis may be processed based on the causally oriented data models will now be described with reference to FIG. 2. A possible procedure for the generation of causally oriented data models based on hierarchically structured data models will be described in more detail with reference to FIGS. 5 to 7.

FIG. 2 is a schematic block diagram showing functional entities of a possible analyser arrangement. The analysis can be seen as being divided between different hierarchical layers. Various possible processing functions are shown in a processing layer 20, the processing layer 20 comprising functional entities such as a Bayesian network (BN) inference engine 21, a directed acyclic graph (DAG) creator 22, and a root cause analysis (RCA) model manager 23.

The BN inference engine 21 is adapted to produce reasoning under uncertain and/or incomplete data on possible root causes of a failure or other abnormality based on evidences entered as symptoms in the RCA model manager 23. The inference engine 21 is arranged to perform a simultaneous verification of a number of root cause hypothesis. The simultaneous processing of the hypothesis can be facilitated by use of causally oriented graphical models. A causally oriented graphical model can be described as being a combination of probability theory and graph theory. The causally oriented models can be seen as models that are oriented based on causal associations the various nodes of the model may have with each other.

The RCA model manager 23 facilitates browsing, searching and filtering of root cause analysis (RCA) models stored in a library of RCA models 33. The RCA model manager 23 may also be used by the operator or another failure analyst to enter observed and/or measured symptoms of the problem domain into the analyser system.

The data layer 30 is shown to contain entities for storing structured data models in the library of root cause analysis models. These models are stored in a selected format wherein the data is arranged in a logical or structured order (e.g. as an hierarchically structured XML file). However, as will be explained in more detail later, the Inventor has found that this format may not always be the best suitable data model for the root cause analysis. Therefore an entity 32 for storing causally oriented data models that are generated based on the hierarchically structured models is also provided.

A example of data structure that can be more readily processed by the Bayesian network (BN) inference engine 21 is a graphical BN model that is referred to as a directed acyclic graph (DAG). The directed acyclic graph (DAG) creator 22 is a translation engine that is arranged to generate a directed acyclic graph (DAG) based on structure data such as a hierarchical RCA model. The DAG creator 22 may be provided with a functionality such as a XML parser for the translation of the XML model structure into a causally arranged data structure such as to a directed acyclic graph (DAG).

It shall be appreciated that the FIG. 2 block diagram is a highly schematic presentation of possible entities and their relations. It shall also be understood that although the entities for analysis and for generation of the causally oriented data models are shown in a single presentation, in the preferred arrangement the data generation is accomplished by the provider of the data models whereas the actual analysis based on the generated data models is accomplished by the operator. That is, the data models may be generated in a location and by an entity that is not physically in the same location wherein the data models are used for analysis.

In accordance with a preferred embodiment the analyser comprises the inference engine. The required causally oriented data models are then provided for the analyser by means of the data storage medium. These models are generated by the provider of the data storage medium. The provider may also be the holder of the structured RCA models and/or other gathered data about the subject of the analysis. This may be done e.g. in applications in which causally oriented data models are not to be updated.

In accordance with another embodiment, the analyser is also provided with a translator function (e.g. the DAG creator 22 of FIG. 2). The analyser may then be provided with the causally oriented data models and/or structured data in a data storage medium.

The storage medium may contain, in addition to the causally oriented data and/or the structured data, the translation engine and/or the inference engine. That is, the data storage medium may contain a complete set of means (data models and engines for processing the data) required for implementing the analyser function.

A feature of a causally oriented model is that it contains information regarding the so called chain causalities. The chain causalities allow identification of the possible root causes of a failure. The causality also allows simulations of possible consequences of interventions e.g. by an operator to a process.

A causal directed graphical model is typically built of discrete and continuous decision nodes or objects. The graphical structure of the model is based on assembly of root cause and effect nodes “connected” by the causality links.

The causality links present probability potentials. That is, an causality link from node or object A to B can be seen as indicating that A is likely with some certainty to “cause” B. The causality links are sometimes referred to as ‘arcs’. The causality links may be based on appropriate probabilistic methods.

The input for the discrete nodes can be classified into different states. In substantially simple applications parameters such as binary states or intervals of typical parameter variations can be used. The input in the continuous decision nodes can be any type of random variable distribution. For example, Gaussian distribution or superposition of several Gaussian distributions may be used to approximate any continuous distribution.

Conditional probability distribution (CPD) may be assigned for each node of the graphical model to complement the structure thereof. If the variables are discrete, the distribution can be represented by means of a conditional probability table (CPT) with respect to the parents of the node. The table lists the probabilities a child node has on each of its different value for each combination of values of the parent node thereof.

An initial causally oriented data model may thus be complemented based on additional information. That is, a completed BN model can be generated based on said directed acyclic graph (DAG). The completion may be based on quantitative information from another type of structured data associated with conditional probability distributions between at least two objects.

The completion of the directed acyclic graph by at least one conditional probability table can be seen as an operation that corresponds to filling the uniform CPTs with typical values of conditional probabilities for a certain state of a child (effect) object under the condition of certain states of the parent (cause) object(s). These typical values of conditional probabilities represent the conditional distributions for the discrete or continuous random variables (=nodes i.e. objects) in the BN. The data model stored in the storage medium 4 of FIG. 1 may thus contain the directed acyclic graph that is complemented with at least one conditional probability table.

Alternatively expressions may be defined, said expressions representing the conditional probability distribution of variables i.e. objects in the causally oriented data model.

The conditional probability tables may provide information regarding the causality relations between the variables thereby allowing probabilistic reasoning under uncertainties. More particularly, a conditional probability table may express causality relations in terms of conditional probabilities between the child node (e.g. observed/measured/calculated symptom or effect) and its parent nodes (e.g. the causes or conditions causing changes in the child node states).

The conditional probability tables may also be generated based on existing expertise and/or data regarding the facility such as statistical and/or physical models, on experience (e.g. on the operator belief on causality) and so on.

The completion of the acyclic graphs may be accomplished by an expert or automatically by filling in the conditional probability tables with probability values. An expert of the problem domain may provide information such as the failure frequencies (recalculated to prior probability) and ranked weightings of the possible root causes (recalculated to root cause probabilities). The obtained probabilities may be transferred by means of an appropriate program code means (e.g. Visual Basic™) into the Bayesian network (BN) in order to complete the CPTs and thus provide the default probability setting in the library of Bayesian models, before evidences are propagated through the BN (and as a result of the inference the root cause probabilities are updated). The automatic filling may be accomplished by statistical processing of database information related to failure frequencies in the problem domain. The probability values may be based e.g. on statistics of the problem domain such as the frequency of the failure or a database of representative earlier cases for the same failure type in the equipment. This information may have been gathered from a plurality of sources, such as from testing laboratories and facilities using the particular equipment.

Creation of the initial BN graphs can be done automatically i.e. without intervention by the user. This saves development time. Use of data that already exist in a hierarchically organised data structure may also reduce significantly the engineering efforts on transferring the collected domain knowledge and operator experience that is obtained e.g. through interviews on the plant into BN compatible graphs.

The skilled person is familiar with the principles of a Bayesian Network (BN) and the elements of a Bayesian system for data learning, adaptation, tuning and automated hypothesis verification, and these are therefore not explained in more detail herein. Those interested can find a more detailed description of the directed graphical models and conditional probability distribution e.g. from an article ‘An introduction to graphical models’ by Kevin P. Murphy, 10 May 2001 or from a book “Bayesian networks and Decision Graphs” by Finn Jensen, Aalborg University, Denmark, January 2001.

Completed BN models may be stored in the data storage medium 4 for later use by the inference engine 21 of the analyser 3. The BN inference engine 21 may fetch an appropriate BN model from the library of models 32. The selection of the required model can be done automatically from the Bayesian Model library based on observed failure and problem domain.

In accordance with a further embodiment the inference engine 21 may also access evidences automatically from a control system such as a distributed control system (DCS). The operator may also input evidences. The evidences may be propagated through the BN model 32 to produce a guidance list with ranking of most probable root causes and a list providing an optimal sequence of control, operation and/or maintenance actions. This allows individual root cause analysis of a particular equipment based on individual evidences gathered for said particular unit.

The various entities of the processing layer may access additional information via an interface element 10 of a control module 40. The control module 40 may comprise an automated functionality for controlling a facility. It may be integrated with an operate module 10 to provide a user interface for operators. The control and operate modules may be provide in a common control platform.

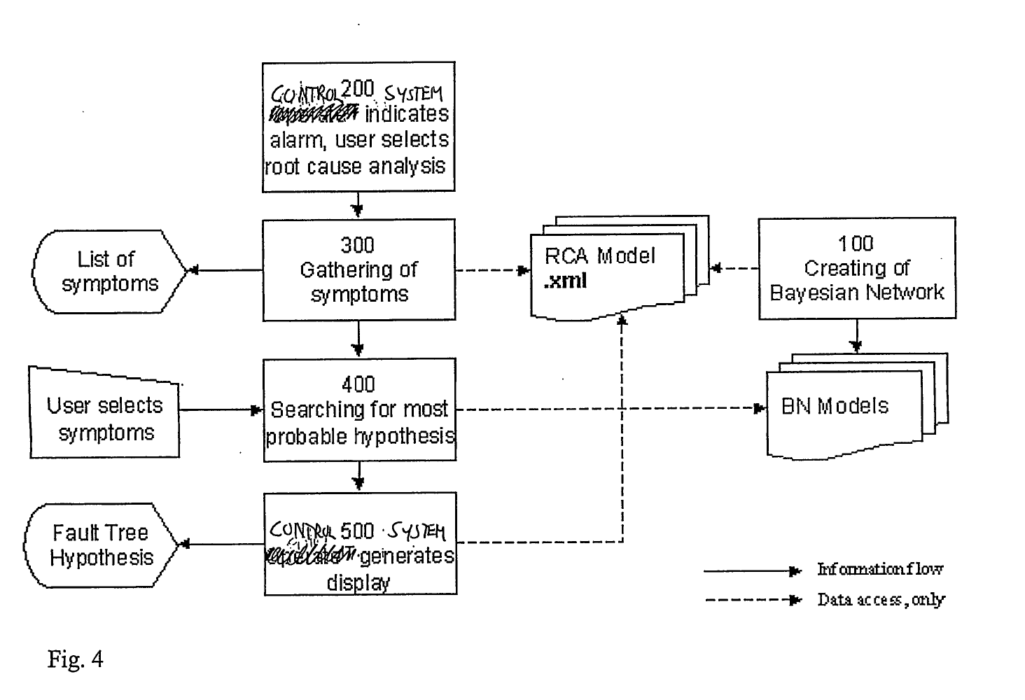

FIG. 4 shows a scheme for automated simultaneous verification of several root cause hypotheses based on Bayesian technology. More particularly, a possible way of performing a fixed Bayesian scheme for root cause analysis is shown. As shown by FIG. 3, the first step comprises translation of a hierarchical XML data structure through XML parsers into a directed acyclic graph (DAG), this step being performed by the provider of data models for analysis. The DAG contains for each causality link of the graph a uniform conditional probability table which will then be filled in i.e. completed (if necessary) with probability values. The probability values are representative of the particular problem domain to build a BN model for root cause analysis with regard to the specific equipment to be analysed.

Before explaining the analysis process of FIG. 4 in more detail, a reference is made to FIGS. 5 to 7 showing in more detail hierarchical and causally oriented data structures while explaining a more detailed example of the generation of the causally oriented graph and completion thereof by the conditional probability tables.

As mentioned above, data about the subject of an analysis may be organised in a structured manner such as in a hierarchical data file structure or model. In a hierarchically arranged data structure a failure object forms the parent object of a hierarchically structured data model generated for a failure.

Since there are typically a plurality of possible causes for a failure, the parent object has a plurality of child objects presenting the possibilities. The possibilities are referred to in the following as hypotheses. Each of the hypotheses in turn may parent a plurality of child objects. These are referred to herein as symptoms. The symptoms represent abnormal changes in the process operation conditions, which lead to a failure in the problem domain (e.g. process and/or its operation and/or equipment and/or component).

FIG. 5 illustrates an hierarchical data structure such as an extended mark-up language i.e. XML data structure or any other file that is created based on the Standard Generalised Mark-up Language (SGML) format. The hierarchical structure may be parented by a failure node or object F. The hypotheses form child nodes H1 to H4 of the failure object F. Each of he hypothesis objects H1 to H4 in turn has child nodes S referred to as symptom objects. It shall be appreciated that two or several of the hypothesis nodes H1 to H4 may parent similar symptom objects.

If hierarchically structured data is used, the analysis is made so that the operator examines a hierarchically organised data structure displayed to him/her by a display device. The data examination of the possible root cause is then made in the direction:
failure ->hypothesis ->symptoms.

As mentioned above, use of the structured data may not always be the most desirable. For example, if hierarchically organised data models are used the operator has to select a hypothesis before being able to get a display of the symptoms of that hypothesis, the displayed symptoms forming a checklist for the operator. The operator may need to check each of the symptoms to find the actual root cause for the failure or other deviation from normal operating conditions. The operator also needs to make intelligent guesses to be able to select a likely (preferably the most likely) hypotheses. The operator may also need to go through a number of the hypothesis and the associated symptoms or even all of the hypotheses and the symptoms thereof before being able to determine the actual root cause for the fault. This may take a substantial amount of time.

The user may need to, for example, click several times by a mouse starting from an the observed failure he has chosen from a number of option in the failure tree. The user needs to manually select by clicking the hypothesis he believes is the cause of the event, and thereafter check all symptoms for the selected hypothesis. If it turns out that the selected hypothesis is not the correct one, i.e. not the root cause of the problem, the user has to start the procedure again with and select the another hypothesis.

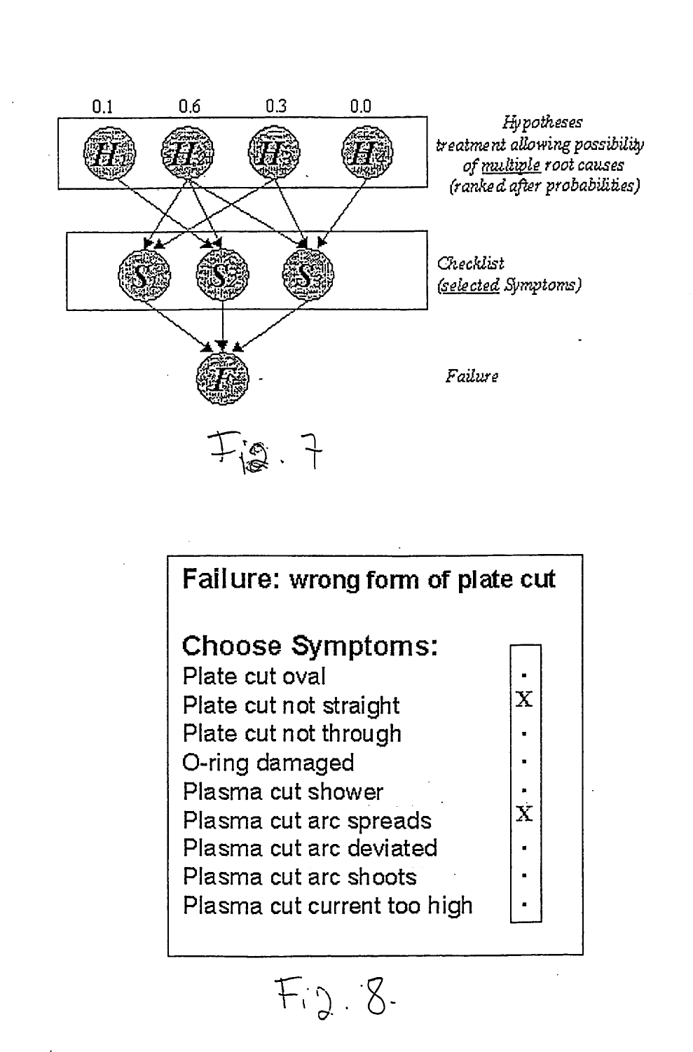

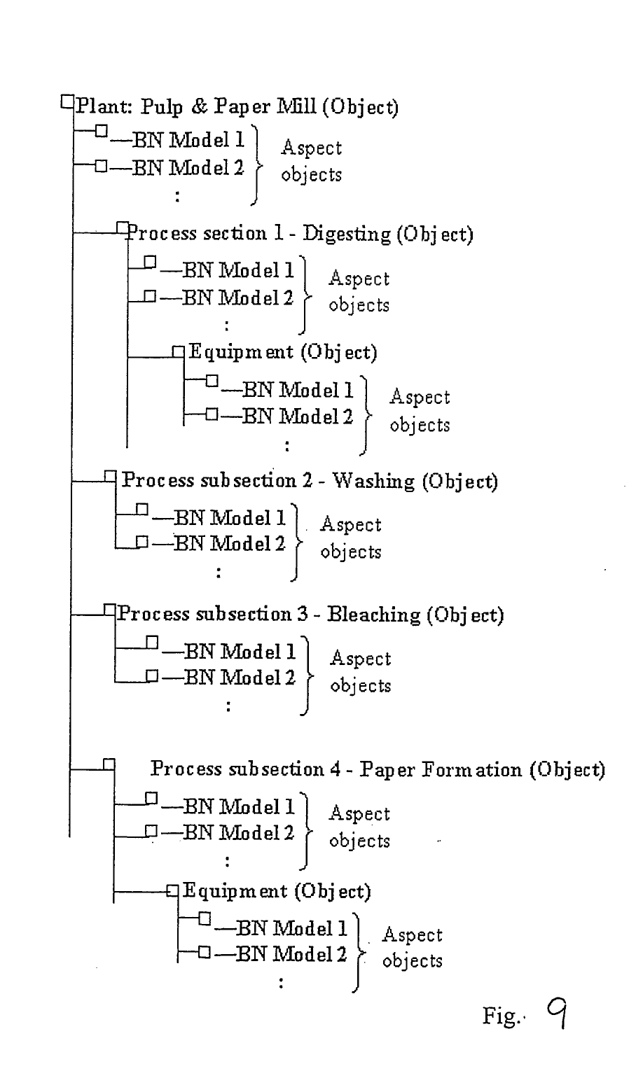

The causality links of a causally oriented graphical data model are, in turn, oriented from cause to effect. FIGS. 6 and 7 show two different types of causally oriented graphical data models into which the hierarchical structure of XML-data of FIG. 5 can be translated.

More particularly, FIG. 6 shows a BN structure wherein a single fault is assumed to have occurred in facility that was working normally until the detection of a failure or abnormality. The single fault assumption is thus represented by a single root cause node with mutually exclusive states. In FIG. 6 each of the mutually exclusive hypothesis of the one hypothesis node H has been assigned with a weight according to the probability of each of the hypothesis H1 to Hn. FIG. 7 shows a BN structure for multiple causes of an observed failure. The mutually non-exclusive multiple root causes are ranked after probabilities as shown on top of each hypothesis node H1 to H4. Each of the hypothesis nodes H1 to H4 is given a weight in accordance with the probability thereof. The causality chain in both of these the causally oriented data structures is:
root cause→symptoms→failure

The probability of the hypotheses i.e. possible root causes may be updated each time the inference engine receives new evidences on the set of symptoms.

As shown by FIG. 5, the hierarchically organised data is stored in the form of a fault tree. The tree may include hypotheses on possible root causes and corresponding checklists (lists of symptoms). As discussed above, the hierarchical failure tree can be mapped into a BN model. An example of the translation is described below assuming that the XML hierarchical data of FIG. 5 has the following structure:

Failure

Hypothesis 1

Check point 1.1
...
Check point 1.n

Hypothesis k

Check point k.1
...
Check point k.m

This structure may be transferred to a DAG such that a failure from the XML model is mapped into an observed effect failure node in the BN model. The check points of the XML model (i.e. the symptoms) are mapped into symptom nodes of the BN model. However, the XML structure does not contain explicitly any causal links. Instead, the XML data is organised in hierarchical levels, where each failure level contains a number of hypothesis sub-levels and each hypothesis sub-level contains as sub-sub-levels a number of checkpoints. These XML hierarchical level-sublevel-sublevel structure, however, can be mapped into causality links (root cause ->symptom; symptom ->failure) in the BN graph. This can be seen as corresponding to assignment of default CPTs with uniform probability on the corresponding states of all observed symptoms and effects.

The symptom nodes of the BN graph can be of different character. For example, discrete nodes with mutually exclusive states may be provided. The exclusive states may be binary (=Boolean) states such as “yes” (=“true”) when a symptom is observed and “no” (=“false”) when a symptom is not observed. The states may also indicate other features such as the intervals of the symptoms, relative symptoms levels (e.g. the ratio between measured value at an observation time point and value of the last set point) and so on. If a single fault is assumed to have occurred (FIG. 6), the states may also represent mutually exclusive types of failures for the same object. For example, a node “plate cut quality” may be provided with states: “OK”, “OVAL”, “CUT NOT STRAIGHT”, “CUT NOT THROUGH”. Continuous nodes may represent continuous random variables with defined statistical distributions, like Gaussian (normal) conditional distribution or superposition of Gaussian distributions.

Several nodes for the states at consequent time points may be used to incorporate symptom trends into the analysis. For example, a trend can be determined based on changes in the symptoms at different time points.

Hypotheses of the XML tree are then mapped into root cause nodes of the BN graph. The mapping of the XML hypotheses into the root cause nodes can be accomplished in different manners depending on the type of the failure (single or multiple causes). The creation of a BN model from a hierarchical failure tree may include different subsequent mapping stages.

A single cause of a failure can be represented by one root cause node, see FIG. 6. The one BN node may have states that are mutually exclusive hypotheses. The main assumption for applying the single fault modelling approach is that everything was properly functioning before the failure was observed. The list of mutually exclusive hypothesis may include a hypothesis ‘normal’ (i.e. no fault).

Multiple root causes of a failure can also be represented by binary nodes with states “yes” and “no” for each hypothesis, see FIG. 7. More than two states may also be used. For example, intervals or trends of the possible cause development can be used as classification criteria.

The next possible mapping stage comprises mapping of the relations of the hierarchically organised XML data structure between the checkpoints and the hypothesis into causality links of the BN graph. The mapping of the causality directions from cause to effect is important for the correct translation of the causality links (expressing dependency relations), which is crucial for the reasoning, i.e. propagation of evidences by the inference engine.

If several hypothesis share the same symptoms, several causality links may then lead from those hypothesis to the same shared symptoms. The mapping will allow creation of causality links within the same parent/child XML structure. The orientation of the links will be defined by the mapping from hypothesis (root cause)->to check points (symptoms)->failure.

An XML model does not contain quantitative data on failure frequencies or statistics, and therefore the XML data does not allow filling of the CPTs with the proper probability values for the corresponding problem domain. The quantitative information on failure frequencies and/or weighing of root causes can be filled in another type of file (e.g. into a spreadsheet such as an EXEL-arc). The other type of file may also contain information regarding the probabilities of the problem domain. The obtained probabilities may be transferred into the CPTs (replacing/updating the uniform/initial default values) in order to complete/update the DAG and to obtain the completed BN model. The transfer may be accomplished by means of another program code.

Under the assumption of a single fault (FIG. 6), the number of the hypothesis is mapped into one root cause node of the BN model with the same number of mutually exclusive states representing the number of hypothesis. An extra state may be used for allowing the possibility of no fault or another fault hypothesis than those already listed.

To incorporate the possibility of multiple faults (FIG. 7), the number of hypothesis from the XML model may be mapped into the same number of root cause nodes in the BN model with Boolean states. Again, an extra root cause node may be employed for the possibility of another fault hypothesis than those already listed.

It shall be appreciated that FIGS. 6 and 7 present only simple BN models and do not show presence of possible causality relations between the different symptoms and/or presence of intermediate causes as effects of the root cause. If causality relations exist between the symptoms the models may be modified to take this into account by adding appropriate causality arrows and the associated conditional probability tables (CPTs). The causality arrows shall be understood as being graphical object that present the conditional probability tables.

Returning now to FIG. 4, BN models are first created based on the RCA models stored at the data storage 33, step 100. An initial BN graph i.e. a directed acyclic graph (DAG) is preferably created off-line from a RCA model. The directed acyclic graph structure is then completed with at least one conditional probability table (CPT) to build a completed BN model for the diagnostics.

The BN models are preferably generated when the analysis system is developed. The BN models for the root cause analysis (RCA) are stored in a storage medium such that the created BN data models can be accessed later on by an analyser entity. The off-line generation of the BN models may save time later on if BN models for a corresponding problem domain are needed. Another advantage of the beforehand generated BN models is that the search may be executed directly on the most probable root causes without requirement for any translations between the two different data structures before the analysis.

Information about only a limited number of faults may be stored in the storage mediums. A complete BN model can be created for each fault. A BN model preferably includes all hypotheses on possible root causes of a failure and/or other abnormality. A simultaneous evaluation of all hypothesis can be done by supplying to the inference engine 21 only once all evidences on acquired symptoms from the problem domain. In the more conventional arrangements (e.g. in those based on the structured data) such simultaneous processing is not possible. Instead, evidences relevant to a single hypothesis need to be supplied and evaluated separately from similar processing of other hypothesis.

According to a possibility, if several faults share a great number of similar symptoms, one BN model can be generated for simultaneous hypothesis verification on the root causes of several failures and/or abnormalities.

A complete BN data model reflects the hierarchical structure of a hierarchically arranged data structure of the corresponding RCA model 33. If the hierarchical XML data structure does not exactly include the right order of causality directions (as is the case in FIG. 5), proper causalities can be incorporated into the BN model during the translation procedure.

At step 200 the control system gives a fault alarm to the operator. The operator decides to use root cause analysis (RCA) to analyse the fault. To initiate the analysis the operator selects appropriate function by means of the user interface of the analysis system, e.g. by the user terminal 10 or a portable user device 40 of FIG. 1. The root cause analysis can also be triggered automatically e.g. in response to a Distributed Control System (DCS) alarm.

The control system may gather evidences i.e. symptoms of the fault at step 300 by loading a corresponding RCA model 33 through the RCA model manager 23. The gathering of evidences may occur simultaneously with the selection of the root cause analysis (RCA) at step 200. The step of gathering may comprise classification of evidence signals gathered as symptoms and additional information provided. Discrete evidences may be classified into different states and/or variation intervals. Evidences that are of continuous type may be classified into mean and standard deviation (or variance) classes. The classification is preferably accomplished in real-time. The classification function may be included in the root cause analyser 3 or in the control system 1 of FIG. 1. In the latter case the classified signals may be transferred as real-time evidences to the analyser. The symptoms i.e. the evidences can then be propagated through the Bayesian network that is searching for the most probable root causes of the observed fault.

The initial or basic information for the causally oriented data model is generated before the fixed data models are generated. In the data models the initial data is then appropriately placed in the problem domain. During the generation of the basic information a list of symptoms may be completed based on information from the operators who may have experienced similar situations before. At least a part of the symptoms may be provided by sources such as system monitoring existing equipment during their operation. For example, information about the symptoms may be provided by measuring instruments means such as temperature, pressure or moisture sensors, or information gathering means such as video cameras, microphones, smell sensors (artificial noses, gas sensors), microphones and so on. The list of symptoms may be provided by utilisation of control system functions such as measurements, calculations or other monitoring parameters which are entered as evidences on the state of symptom nodes. The list of evidences can be completed by automatic computations by appropriate models describing the system, such as performance models and/or physical and/or statistical models.

Gathering of information may also be required when analysing the equipment, this information forming the evidences. The gathered evidences are then propagated through the BN model by the inference engine in order to find possible root causes for the deviation from the normal conditions.

A simultaneous hypothesis verification can be performed at step 400 after the data content in the storage medium containing the BN model has become available for the analyser function. The analysing step determines a weight for each of the possible hypothesis based on the probability thereof, the simultaneous hypothesis verification being for determining the most probable root cause of a failure. The simultaneous verification of more than one hypothesis together with analysis of a fixed number of variables provides savings in time as compared to the prior art where all hypotheses had to be checked one after the other. Thus, significantly quicker fault isolation may be obtained.

Searching for the possible root causes of a failure can be seen as a diagnostic application of the BN model. The probabilistic reasoning in diagnostic applications is performed in direction opposite to the causality links. That is, the inference engine 21 may calculate the probable root causes (hypotheses) starting from the observed failure and then from symptoms without being forced to select the hypotheses first. In addition, the causality structure of the network allows examination of the impact of intended interventions, which can be very useful for control of complex processes in order to examine operation actions, which might have unwanted or dangerous consequences.

At step 500, a ranking of possible root causes is displayed for operator. The obtained root causes may be ranked based on their probabilities before being presented to the operators and/or maintenance personnel. This may be used to provide improved operator guidance and decision support on control and/or maintenance activities.

The operator may be presented with a list of representative symptoms for a fault domain. The operator may then choose from the presented list the observed/measured symptoms of the fault. FIG. 8 shows an example of a list that relates to a cutting process for steel industry. In this example an alarm signal ‘wrong form of plate cut’ is given by the control system. The operator has decided to analyse the problem by means of the analyser performing root cause analysis. Before initiation of the analysis the operator is presented with a Graphical User Interface (GUI) for selecting the observed symptoms.

The operator may select all observed or measured symptoms from the symptom list of a failure indicated to him/her as an alarm. The combination of the selected symptoms may then be entered as evidence to the Bayesian inference engine 21 for the hypothesis verification to produce a list of possible root causes. The mapping may be accomplished by the DAG creator 22. This is done by mapping the object of FIG. 5 into the data model of FIG. 6 (single fault assumption) or FIG. 7 (multiple faults possibility).

The proposed diagnostic system may be implemented by means of object oriented programming techniques wherein at least some features are provided as an aspect of an object. The aspect and objects can be employed in a platform of a control system that is adapted for object oriented data processing. Object oriented programming techniques or languages were developed to ease incorporation or integration of new applications in a computerised system. A data object may represent any real life object or equipment such as, without being limited to these, a device or a component of a device, a cell, a line, a meter, a sensor, a sub-system, a controller, a user and so on. An aim of the object oriented techniques is to break a task down to smaller autonomous entities that are enabled to work together to provide the needed functionality. These entities are called objects.

During development of a set of control instructions or control software based on the object oriented techniques the designer may determine what objects are needed for the instructions and the interrelations each of the chosen objects has with other objects. When the control program is run a functionality of the program may call an object that is stored e.g. in a database of the control system. A feature of the object oriented methods is that an object can be called and located by the name of the object.

An object may have different aspects, each aspect defining more precisely features such as a characteristic and/or function and/or other information associated with the object. That is, an object may associate with one or more different aspects that represent different facets of the entity that the object represents. An aspect may provide a piece of the functionality of the object. An aspect may be either exclusive or shared by several objects. An object may also inherit an aspect from another object. The different facets of a real world object may comprise features such as its physical location, the current stage in a process, a control function, an operator interaction, a simulation model, some documentation about the object, and so on. The facets may be each described as different aspects of a composite object. A composite object is a container for one or more such aspects. Thus, a composite object is not an object in the traditional meaning of object-oriented systems, but rather a container of references to such traditional objects, which implement the different aspects. Typically the composite object would be a software object representing a real world entity.

International publication No. WO 01/02953 entitled “Method of integrating an application in a computerised system” is a more detailed description of a method to represent real world entities in a computerised system. In such a method and system, different types of information about the real world entity may be obtained, linked to the real world entity, processed, displayed, acted on, and so on. An application that may be used to provide some function of real world entity defines interfaces that are independent of the implementation of the application itself. These interfaces may be used by other applications, implementing other aspects or groups of aspects of a composite object. The WO publication No. 01/02953 describes also a method in which a software application can query a meta object such as an object representing a real world entity (entity object) for a function associated with one of its aspects. A reference to the interface that implements the requested function can then be obtained through the entity object. In the present invention at least some features of the diagnostic system may be integrated as an aspect of an object in the control system platform and/or accessible to the control system.

FIG. 9 shows possible real world objects and the associated BN models for a stage of a continuous process such as for any process stage of a paper mill. The BN models are integrated as aspect objects in a model describing the process. Each process stage (e.g. Digesting, Washing, Bleaching, Recycling, Paper Formation, Evaporation, Recovery & Re-caustisizing) can be modelled separately beforehand and included as an object aspect in the P&P Mill model. The introduction of different aspects can be done at different times.

If an update of the BN model is required, e.g. if new symptoms, new root causes and/or changes in the CPTs are to be introduced, the update may be accomplished by updating the data models by the data provider and then replacing the data storage medium at the analyser. If the above referenced aspect/object technology is used, an aspect may be replaced by an updated version thereof.

The update may be e.g. based on operator feedback. An existing BN model may be tuned with failure cases representing the problem domain.

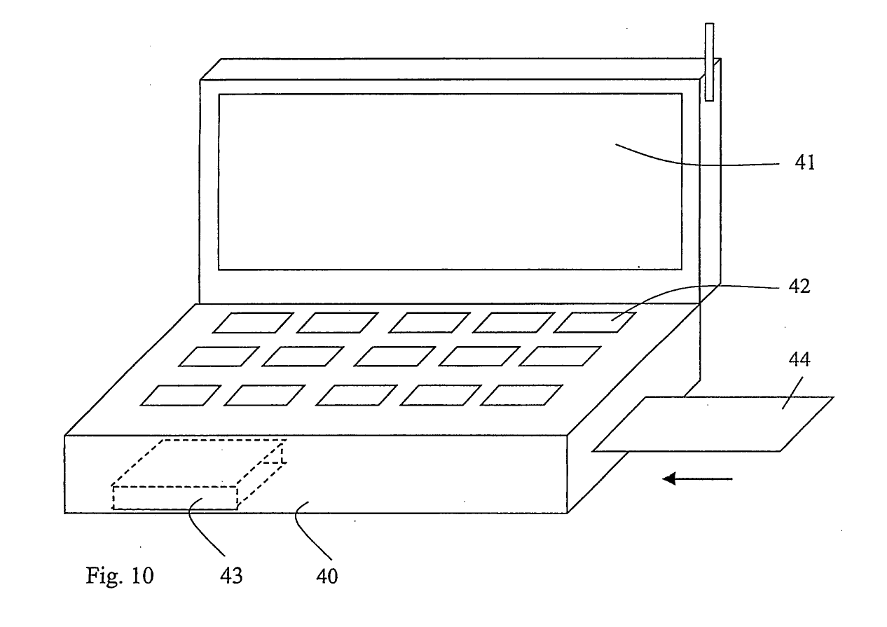

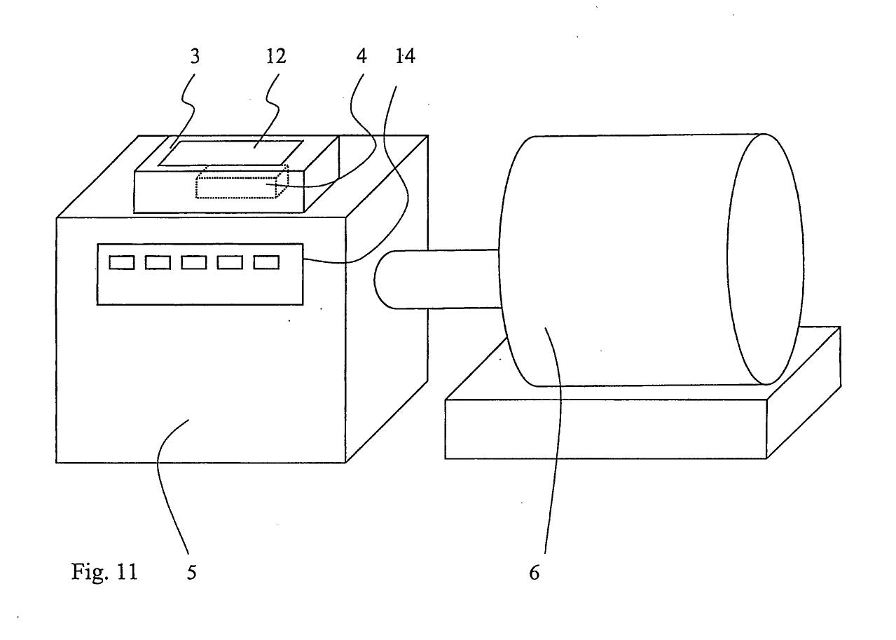

An embodiment wherein a portable device 40 may be used is now described with reference to FIGS. 1 and 10. The device 40 may be provided with an analyser function. The portable device 40 may also be adapted to allow the operator to input data after manual inspection of symptoms or devices e.g. for collection of data for an update of data model.

A beforehand prepared data model as described above and the other required analysis functions may be provided in the portable or otherwise mobile device 40. All processing associated with the actual analysis may then be performed at the portable device. The data may be stored e.g. in the fixedly mounted storage means 43 of the device (e.g. a memory chip or card), and/or in a replaceable data storage medium 44. All functions that were described with reference to the analyser 3 associated with the control system 1 may be provided by the analyser 40.

Alternatively or in addition, the portable device 40 may be arranged communicate with the control system 1 and/or the analysis system 3 of FIG. 1 via a wireless interface. Thus the device 40 can be used to improve the chances that correct information is input in substantially real-time manner into the control and/or analysis system.

The portable device 40 may comprise a display 41, control buttons 42 and/or other user interface (e.g. one based on voice messages, touch screen, indicator lights and so on) for representing e.g. an optimal sequence of actions to be taken, an appropriate action to be taken by the user of the device, or probabilities of simulated effects from an intended action. The display may represent a ranked list of possible causes and the optimal sequence of repair actions or any other actions the operator could take. The display may also present an optimised path how to walk or otherwise move around in the plant, or an optimised time after which a check needs to be made on those local instruments which are not sending signals to the control system 1. In addition, an optimal sequence of actions and so on may be presented to the operator until the source of the failure or abnormality is found and removed.

A portable or otherwise mobile analyser device 40 may be advantageous e.g. in analysing components of an industrial process or other facility wherein a number of manually operated equipment (such as valves, switches, gears, various meters and so on) is provided. The manually operated devices 5 to 7 may be located substantially far away from the operator's workstation 10. Because of this there may from time to time exist a need for a tool for helping the operator e.g. to input the symptoms in the root cause analysis system at the spot, that is whenever he/she feels it necessary to provide such information for the analyser. The input symptoms may be processed in a substantially real-time manner thereby providing a substantially real-time analysis “on the spots”. The symptoms may be of a predictive character, thus enabling the operator to “test” what will happen is a particular action is taken by him. The predictive character of the symptoms may enable analysis based on which it is possible to take necessary corrective actions before any actual failure or other deviation from optimal operation conditions occurs.

According to an embodiment shown in FIG. 11 the data storage medium and/or the analysis software and the hardware are provided at the equipment to be analysed itself. For example, a device or a stand-alone device such as an equipment unit comprising a pump 6 and a motor 5 is provided with at lest a part of the required analysis software and hardware 3. Memory means 4 are also provided for storing the required data for the analysis. The memory means 4 may be of a type that can be updated or they may simply comprise a fixed data storage medium for storing the beforehand prepared data, preferably the beforehand prepared causally oriented data models. User interface means may also be provided e.g. by means of a display 12 and input means such as buttons on a control panel 14. The display 12 is arranged to present the operator with the results of the root cause analysis or present any other information is association with a performed or to be performed root cause analysis. The operator may input any data required for the analysis by means of the input means.

The analyser entity 3 integrated or closely associated with the actual equipment to be analysed may be self-activating and/or may be activated by the operator. If the analyser is self activating, it may generate and/or present alarm messages to the operator. The analyser entity 3 may also be authorised to initiate e.g. self-correction action, a shutdown action or any other predefined action in response to a predefined root cause.

According to a possibility (not shown) the beforehand prepared data models are transferred via a data network (e.g. the Internet, an intranet, a local area network (LAN) and so on) to a local customer entity. The local entity may be an analyser or a machine provided with an analyser facility, as described above provided with means for interfacing the data network. A data entity containing the beforehand prepared data model may also be delivered into a server of the local user. The analyser may then fetch the data entity from the server whenever it needs the data for analysis. A root cause analysis system that is based on use of a data network such as the Internet or an intranet or LAN may be advantageously used in application wherein similar equipment to be analysed operating on similar principles and exhibiting similar mechanism of failure/abnormality appearance is located in various locations.

The embodiments of the invention may be employed, for example, in a diagnostic arrangement which exploits a probability based approach for reasoning under uncertainties in an analysis system providing root cause analysis.

The proposed analysis system may provide a quick and flexible tool for troubleshooting and/or predictive analysis in association with widely used equipment. The benefits may include reduced breakdown times, increased productivity and efficiency of the overall system employing the equipment. In addition, basic analysis data is provided such that it is ready for use, as there is no need to train the basic data before use for analysis. In addition to generating information regarding events that have already occurred, the analysis may be used for prediction purposes such as for simulation of impacts an action taken by an operator may have before any real action is taken.

The solution may be applied to any industrial or other facility. An industrial facility may comprise, for example, a manufacturing facility such as a factory or a similar production unit. An industrial facility may also be for provision of different processes such as continuous, discrete, or batch like processes and so on. For example, but without being limited to these, the solution can be used by industrial facilities of metal, foundry, pulp, paper, cement, minerals, chemical, oil, gas and other petrochemicals, refining, pharmaceuticals, food and beverage, automotive industries, automatic storage and/or handling systems (e.g. freight handling systems such as airport baggage loading and transfer systems), communication systems, buildings and other constructions and so on. The solution may be used in association with new equipment/systems or existing systems.

The analysis may be triggered automatically e.g. in response to an alarm by a control system or manually by an operator. Simultaneous verification of a plurality of hypothesis is a feasible solution since all observed symptoms can be entered as one set of evidences in a single BN model. For example, a evidence vector containing only numeric values of evinces could be propagated through a BN model. That is, if several faults or other abnormalities share a plurality of symptoms, a causally oriented data model can be generated for simultaneous verification of hypotheses for these. All hypotheses for a certain failure may have been built into said BN model (see the BN models of FIGS. 6 and 7). This may allow higher computational effectiveness. The simultaneous verification of hypotheses may speed up considerably e.g. troubleshooting e.g. in a industrial facility and/or predictive root cause analysis.

Simultaneous processing of hypotheses may be especially advantageous if the root cause hypotheses share several common symptoms. If not, the causally oriented data model may be reduced into a smaller sub-model for processing of only those hypotheses which have received evidences.

A further advantage provided by the use of causal networks lies in the causality itself which allows, in addition to monitoring, diagnostic, and troubleshooting, simulation of the impact of an operator intervention before any real action is performed. This may be crucial e.g. when the consequences of certain operator actions may be undesired e.g. for safety or economic reasons.

The above proposed solutions may provide savings in the time required for searching a fault in an equipment. This may lead to reduction in the costs related to failures and/or abnormalities and other events in a process, equipment, devices, components and so on. Time consumed by unplanned process stops, production losses, losses due to wrong production parameters and poor quality, unnecessary consumption of materials and energy may provide significant advantages. The analysis also may be used for reducing operation and maintenance costs, manpower costs for failure searching and so on. Therefore the overall productivity and efficiency of a facility may be increased by means of the above proposed embodiment.

It is noted herein that while the above describes exemplifying embodiments of the invention, there are several variations and modifications which may be made to the disclosed solution without departing from the scope of the present invention as defined in the appended claims.

1. An arrangement for provision of information about causes of events in association with an equipment, comprising:
a data storage medium for storing beforehand prepared data that associates with the equipment, said data containing predetermined information about events that can associate with the equipment, hypotheses for the root causes of the events and symptoms for the hypotheses; and
a processor arranged to analyze a plurality of root cause hypotheses by processing information obtained from the data storage medium.

2. The arrangement according to claim 1, wherein at least two root cause hypotheses are processed simultaneously.

3. The arrangement according to claim 2, wherein said at least two root cause hypotheses share at least one common symptom.

4. The arrangement according to claim 1, wherein a predetermined number of variables is stored in the data storage medium.

5. The arrangement according to claim 4, wherein a fixed number of variables is stored in the data storage medium.

6. The arrangement according to claim 1, wherein the data is organized in objects, said objects being organized onto a model wherein at least one of the objects includes information about a possible event, at least one of the objects includes information of hypothesis associated with possible root causes of the event and at least one of the objects includes information associated with symptoms of said possible causes.

7. The arrangement according to claim 6, wherein the data model comprises a causally oriented data model.

8. The arrangement according to claim 7, wherein the causally oriented data model is generated by processing a structured data model.

9. The arrangement according to claim 6, wherein the causally oriented data model comprises a Bayesian Network.

10. The arrangement according to claim 6, wherein the causally oriented data model comprises conditional probability information, said information being provided by calculating probabilities based on quantitative data associated with the frequency and/or weightings of the events.

11. The arrangement according to claim 1, wherein data is stored as an aspect of an object in a model describing a facility.

12. The arrangement according to claim 1, wherein the data storage medium comprises a computer readable data carrier.

13. The arrangement according to claim 12, wherein the data storage medium is selected from the list of: a memory chip, a memory card, a memory tape, a compact disk, digital video disk, diskette.

14. The arrangement according to claim 1, wherein the data storage medium comprises a data entity that is provided for the analysis via a data network.

15. The arrangement any preceding according to claim 1, wherein the data storage medium is prepared by an analysis information provision entity, said entity being arranged to gather information from various sources.

16. The arrangement according to claim 15, wherein information is gathered by means of measurement means and/or monitoring means and/or sensors and/or a control system and/or computations.

17. The arrangement according to claim 1, wherein the data storage medium contains at least one causally oriented data model and program code means for processing said at least one causally oriented data model.

18. The arrangement according to claim 1, wherein the data storage medium comprises a structured data model and said processor is provided with translation means for generating a causally oriented data model based on the structured data model.

19. The arrangement according to claim 1, wherein the processor and the storage medium are provided in association with the equipment to be analyzed.

20. The arrangement according to claim 1, wherein the processor and the storage medium are provided in association with a portable device.

21. The arrangement according to claim 1, further comprising input means for input of observed symptoms.

22. The arrangement according to claim 21, wherein the observed symptoms can be input in a substantially real-time manner for provision of a substantially real-time root cause analysis.

23. The arrangement according to claim 1, wherein the results of the root cause analysis can be updated by propagating observed symptoms through the causally oriented data model.

24. The arrangement according to claim 1, further comprising a display for presenting the results of the analysis.

25. The arrangement according to claim 1 providing a decision support tool for the operator of the equipment.

26. The arrangement according to claim 1, wherein a predictive root cause analysis is provided.

27. The arrangement according to claim 1, wherein a predefined action is to be taken in response to the results of the analysis.

28. A data storage medium for storing of data that has been prepared beforehand for use at an analyzer, the data storage medium containing predefined information regarding possible events in association with an equipment in a form of data model that comprises objects containing information about the possible events, about root cause hypotheses for said possible events and symptoms for said hypotheses, and causality links for provision of probabilistic associations between the objects.

29. The data storage medium according to claim 28, wherein the number of variables and/or of failure hypotheses is limited.

30. The data storage medium according to claim 28 or 29, wherein the data storage medium be generated based on information obtained through domain experience and/or expertise and/or other existing data about the subject of the analysis.

31. The data storage medium according to claim 28, wherein the data model with causality links between the objects has been generated based on a structured data model.

32. The data storage medium according to claim 31, wherein the structured data model comprises a mark-up language data file, preferably an XML document and said causally oriented data model comprises a Bayesian Network.

33. A method of providing information about events in association with an equipment, comprising:
preparing a data model that associates with the equipment, said data model containing information about possible events, hypotheses for the root causes of the possible events and symptoms for the hypotheses;
storing the data model on a data storage medium;
input of symptoms into an analyzer;
transferring data from the data storage medium to the analyzer; and
analysing hypotheses for root causes by processing the symptoms input into the analyzer and the data obtained from the data storage medium.

34. The method according to claim 33, wherein a plurality of root cause hypotheses is processed simultaneously.

35. A device comprising:
means for provision of the intended operation of the device;
data storage medium for storing of data that has been prepared beforehand for use in analysis of the device, the data storage medium containing predefined information regarding possible events in association with the device in a form of data model that comprises objects containing information about the possible events, about root cause hypotheses for said possible events and symptoms for said hypotheses; and
a processor for analyzing the operation of the device based on data stored in the data storage medium.

36. A movable device for provision of analysis regarding an equipment, the movable device comprising:
a data storage medium for storing of data that has been prepared beforehand for use in analysis of the equipment, the data storage medium containing predefined information regarding possible events in association with the equipment in a form of data model that comprises objects containing information about the possible events, about root cause hypotheses for said possible events and symptoms for said hypotheses; and
a processor for analyzing the operation of the equipment based on data stored in the data storage medium.

37. The movable device according to claim 36, further comprising a user interface for presenting results of the analysis and/or for input of symptoms for the analysis.

38. The movable device according to claim 37 being arranged to process in a substantially real-time manner the symptoms input into the device.

39. The movable device according to claim 37 wherein the symptoms are of a predictive character.

40. The movable device according to claim 36, arranged to presents at least one of the following: an optimal sequence of actions; an appropriate action to be taken by the user of the device; probabilities of simulated effects from an intended action.
